(19) United States
(12) Patent Application Publication
(10) Pub. No.: US 2015/0369910 A1
(43) Pub. Date: Dec. 24, 2015

(54) ELECTROMAGNETIC PULSE DEVICE

(71) Applicant: Elmer Griebeler, Chesterfield, OH (US)

(72) Inventor: Elmer Griebeler, Chesterfield, OH (US)

(21) Appl. No.: 14/617,461

(22) Filed: Feb. 9, 2015

Related U.S. Application Data
(60) Provisional application No. 62/013,664, filed on Jun. 18, 2014.

(51) Int. Cl. G01S 13/02; G01S 13/88

(52) U.S. Cl. CPC G01S 13/02; G01S 13/885

(57) ABSTRACT

A method and apparatus for communication and the detection of objects comprising signal generating means for generating and transmitting at least one electromagnetic pulse having an asymmetrical shape; signal processing means for receiving a signal or a reflected return signal, and processing the return signal to derive useful information; and at least one antenna for sending and/or receiving signals.

### BACKGROUND OF THE INVENTION

The present invention is directed to a device that uses uniquely shaped, pre-programmed, asymmetrical electromagnetic pulses in a novel way to transmit pulsed radio signals (or pulse mode radio or PMR) for communication, or to detect objects and read out the location, composition, and/or shape of objects.

Radio waves are continuous resonances or oscillations, or short duration pulses or bursts of oscillations such as with radar, for example. Electromagnetic spikes or pulses from electrical sparks and lightning are symmetrical in their plus and minus electric field swings, and symmetrical with time, such as sinusoidal waves. Electromagnetic spikes are subject to a decaying resonance due to encountered resistance in electrical circuits similar to a bell ringing, fading to silence. It is essentially a damped sinusoidal wave whose amplitude approaches zero as time increases.

The detection of objects, which may be buried under packed soil to depths of twenty-five feet, is of interest. For example, one particular interest is the detection of buried utilities, such as phone and cable lines, gas lines, and sewage/drainage lines. Another interest is to locate people in a burning building. Other items of interest include land mines or improvised explosive devices, which should be detectable at a safe distance to avoid injury to persons if such are detonated. The detection of land mines or improvised explosive devices should be done with a high degree of accuracy and speed.

For accuracy there should be as few as possible false positives to avoid having to slow down the detection process by the person doing the detection. An aspect of the invention is to provide a computer program to correlate a partial shape of a buried item with a known item such as an artillery shell. With communication the correlation is with a known bit timing pattern or data code.

Electromagnetic waves are employed in ground-penetrating radar (or GPR) to image the subsurface. GPR usually employs high frequency electromagnetic radiation in the microwave band of the radio spectrum. Often, the depth range of GPR is limited by the electrical conductivity of the ground, the transmitted center frequency, and the radiated power.

For example, U.S. Pat. No. 6,664,914 to Longstaff teaches a ground penetrating radar, and method of operating it, that includes a signal generator, a return signal processor, a gate and an antenna. The signal generator is a dual frequency synthesizer that generates a stepped frequency master signal and a tracking signal offset by an intermediate frequency. The return signal processor is a dual channel quadrature receiver that mixes down a return signal and a sample of the master signal to intermediate frequency using the tracking signal. The signal generator is pulsed by the gate and the return signal is gated at the same frequency. The apparatus can employ hollow pyramidal antennas that have an ultrawide band bowtie structure with antenna electronics located within one antenna element.

U.S. Pat. No. 8,587,477 to Fuller et al teaches a radar system that includes a transmit array made up of a plurality of metamaterial elements and a near-field stimulator for inputting an electromagnetic signal to the transmit array so that a subwavelength target is illuminated with an electromagnetic wave.

US patent publication 2010/0066585 to Hibbard et al sets out a ground penetrating radar system that is described that is able to create both low frequency, wide pulses, and high frequency, narrow pulses, to enable both deep and shallow operation of the ground penetrating radar on demand, including simultaneous operation.

US patent publication 2013/0082860 to Paglieroni, et al., describes a method and system for detecting the presence of subsurface objects, within a medium, where the system operates in a multistatic mode to collect radar return signals generated by an array of transceiver antenna pairs that is positioned across the surface and that travels down the surface. The imaging and detection system pre-processes the return signal to suppress certain undesirable effects. The imaging and detection system then generates synthetic aperture radar images from real aperture radar images generated from the pre- processed return signal and post-processes the synthetic aperture radar images to improve detection of subsurface objects.

US patent publication 2005/0062639 to Biggs discloses a radar imaging apparatus which includes a single transmit antenna and at least one receive antenna scanning means (e.g. a pantograph) for mechanically scanning the antennas over a surface of interest, position providing means (e.g. a computer driving the pantograph via an X-Y drive and a stepper motor) providing a position signal indicative of the instantaneous position of the transceiver, control means for operating the transmit antenna in a stepped frequency continuous wave mode, signal analyzing means for analyzing amplitude and phase components of the receive antenna signal, and signal combining means for combining the output of said signal analyzing means with said position signal as in a synthetic aperture array to provide a radar image signal of the surface and underlying features.

US patent publications 2012/0262325 and 2010/0066585 to Steinway et al., and 2006/0284758 to Stilwell et al., teach an integrated mine detection system which combines a ground penetrating metal detector and a ground penetrating radar detector. U.S. Pat. No. 7,333,045 to Aomori et al also teaches a combined metal detector and ground penetration radar, which uses plural antenna elements disposed on a circumference and arranged at a periphery.

U.S. Pat. No. 8,115,666 to Moussally et al., teaches a method and system for examining subsurface targets utilizing an elevated or airborne platform using a broad spectrum of frequencies transmitted from the platform and is directed at the various subsurface targets. A plurality of chirp signals is utilized to transmit the entire frequency range. When these signals are reflected from the various subsurface targets and are received by the platform, they are combined in a manner to allow the visualization of the subsurface target.

U.S. Pat. No. 6,617,996 to Johansson et al. teaches a ground penetrating radar system including a processor for generating audible output signals having discrete frequency components representative of the depth of buried targets where the amplitude of the audible frequency components is representative of the size or mass of the target.

US patent publication 2013/0141270 to Rodenbeck et al teaches an ultra-wideband radar transmitter apparatus which includes a pulse generator configured to produce from a sinusoidal input signal a pulsed output signal having a series of baseband pulses with a first pulse repetition frequency, where the pulse generator includes a plurality of components that each have a nonlinear electrical reactance and the signal converter is coupled to the pulse generator and configured to convert the pulsed output signal into a pulsed radar transmit signal having a series of radar transmit pulses with a second pulse repetition frequency that is less than the first pulse repetition frequency.

### SUMMARY OF THE INVENTION

A method and apparatus for communication, or the detection of objects comprising a signal generating means for generating and transmitting at least one electromagnetic pulse having an asymmetrical shape; a signal processing means for receiving the signal, and processing the signal to derive useful information ; and at least one antenna for sending and/or receiving signals.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic of a circuit used to generate a pulse;

FIG. 2 is a schematic of the electronics to create and receive a voltage pulse with a unique asymmetrical shape;

FIG. 3 is a schematic breakdown of the pulse recognition means employed to generate the signal or image output;

FIG. 4 is a graph of a signal created in the device;

FIG. 5 is a schematic of an antenna to transmit a pulse and receive reflected signals;

FIG. 6 is a set of response signals reflected from metallic objects; and

FIG. 7 is a set of response signals reflected from non-metallic objects.

### DETAILED DESCRIPTION OF THE INVENTION

The present invention is to the use of a system and apparatus for communication, or detecting buried objects using an asymmetrically shaped electromagnetic pulse. The system includes a position sensor, a controller, a pulse generator, an amplifier, a transmitting antenna, a receiving antenna, an amplifier, an analog to digital converter, a pulse recognition and amplitude adjustment means, an image processor, and memory.

The transmitting electronics creates a voltage pulse with a unique, pre-programmed, defined shape. This invention offers a class of electromagnetic pulses that do not occur in nature nor are they used in radio communications. This class of electromagnetic pulses includes electromagnetic pulses that are not symmetrical electrical fields and/or are not symmetrical with time. This allows these pre-programmed, asymmetrical pulses to be easily distinguished from sparks, radio, and background noise.

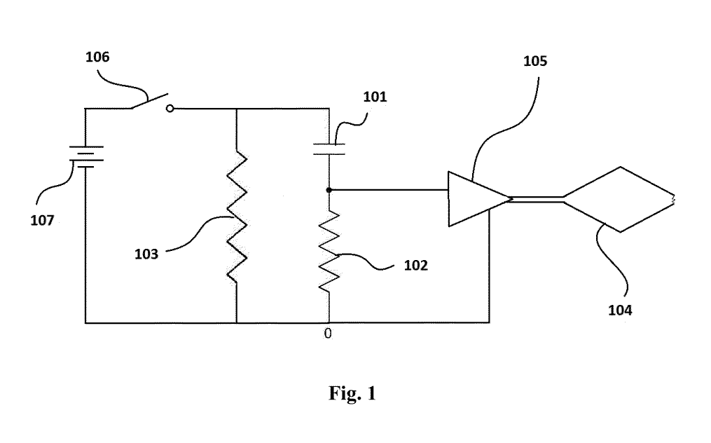

FIG. 1 shows a schematic of the device. It comprises a battery 107, connected via a switch 106 to a capacitor 101 and fast ramp resistor 102 and a slow recovery resistor 103. This circuit is connected to an amplifier 105, which is in turn connected to an antenna 104.

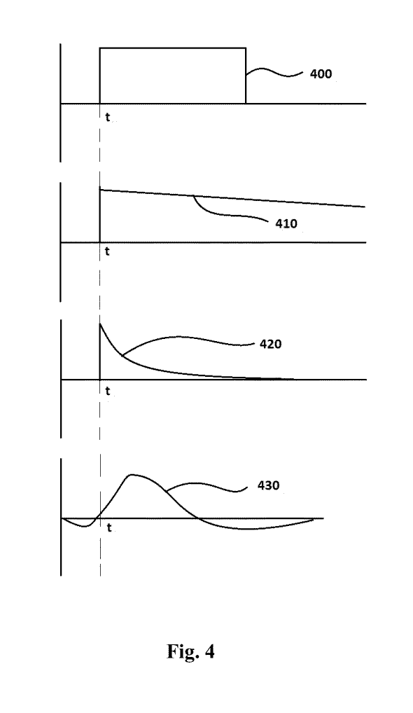

One example of an asymmetrical, unique, pre-programmed, specified pulse shape pulse 420 is illustrated in FIG. 4, which is generated using capacitor and resistor circuits (shown in FIG. 1). In the circuit, at time t the switch 106 is momentarily closed, then opened after approximately 3 nanoseconds (ns), which creates a voltage step 410 in the circuit. The step is actually a gradual decay to zero, lasting approximately 100 ns, and is a result of the interaction of the slow recovery resistor 103 and the capacitor 101. With a voltage step 410 as a source, the capacitor and resistor pass the voltage step as a voltage step followed by a decay 420 back down to zero. The voltage decays to around 30% after about 0.3 ns and returns to zero after approximately 2 ns, and is a result of the interaction of the fast ramp resistor 102 and the capacitor 101. When this wave 420 is connected to an antenna 104, the transmitted waveform 430 transmitted from the antenna is converted to an electric field. As the electric field expands away from the antenna, the corresponding magnetic field is created. The exact times are not critical and can vary, but shorter times allow for a quicker succession of pulses, which leads to faster imaging results.

The antenna converts the voltage pulse into an electromagnetic pulse (EMP). Objects are detected by reflections using electromagnetic pulses. If the EMP encounters an object or any discontinuity, a portion of the EMP is reflected back to the antenna. The reflections occur whether the object is metal, rock, or plastic. A more distant object will return a reflection later than a closer object. Since most objects reflect only a small part of the EMP and transmit most of the rest, many objects along the length of a beam can be sensed.

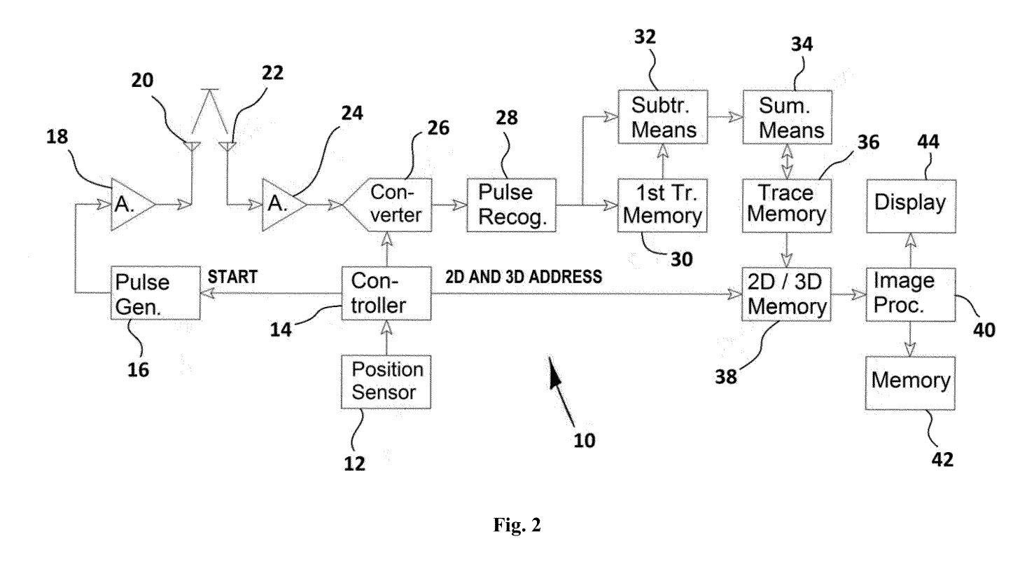

As seen in FIG. 2, the system of the present invention 10 includes a position sensor 12, which is employed to measure the antennae position to create the address to record the traces (one dimensional scans). This will make it possible to produce an image later. The position sensor 12 can be a pulser on the wheel of cart or a movement sensor integrated circuit. The sensor and any transport (e.g. a cart) send a first pulse and receive a first detected response. This is recorded as measurement 1. The cart is moved some distance, which is recorded by the position sensor 12, and a second pulse and received response are recorded as measurement 2. This process is repeated and can continue indefinitely as determined by the operator.

A controller 14 is provided to initiate the transmit pulses, setting the sequence of events, and supplying the address to coordinate the scan movement with the memory. A trace is the sequence of pulse amplitudes sent back from the target versus time. A scan is a series of traces displaced laterally or angularly. On command from the controller 14, the pulse generator 16 creates the unique, pre-programmed, specified pulse shape. A typical unique pulse shape is a sudden voltage rise followed by a slower decline back to zero. This triangular pulse shape allows for high resolution, with the sudden rise in voltage. High recognition is created by the shape of the sudden rise followed by the slower decline. Many other pulse shapes can be used so that in a given space several such Imagers can be used without interference with each other. The unique asymmetrical pulse shape allows stronger recognition of the reflections of the pulse in an electrically noisy environment.

A transmit amplifier 18 increases the power level of the transmit pulse from the low level signal from the pulse generator 16 to a practical power level for transmitting. Due to FCC regulations, this invention transmits at a power of 0.1 watts or less. Higher power increases the recognition of the unique pulse in an electrically noisy environment and with noise generated in the hardware. The increase in power level by the amplifier 18 can range from 1-1000 times, and the present invention typically uses approximately 500× power increase.

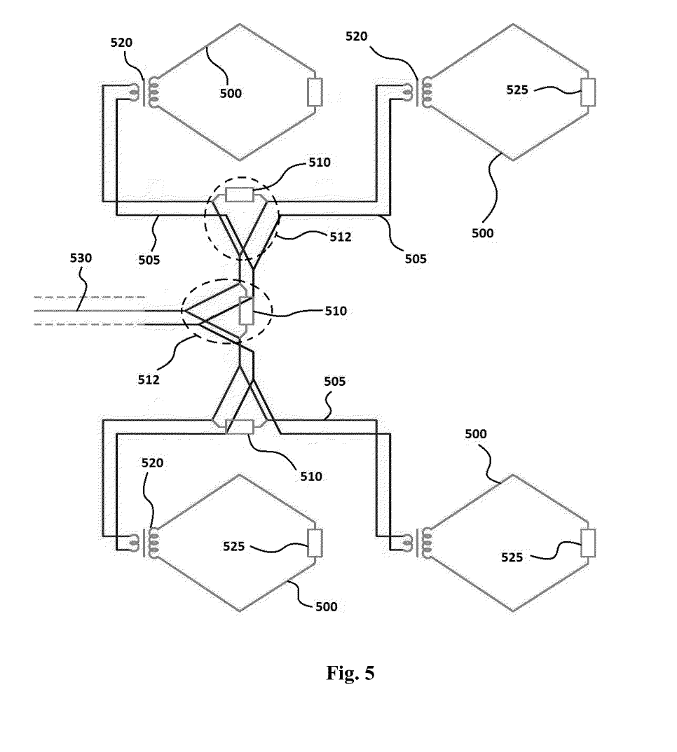

The transmit antenna 20 can be of several variations, but must not significantly distort the unique, pre-programmed pulse shape. In addition, the antenna must produce a narrow beam as needed for the application. One such antenna is shown in FIG. 5, which is an array of rhomboid elements with Wilkinson power splitters, which are known in the art to distribute the power equally amongst the elements. The width of the beam can be reduced by increasing the number and size of the antenna elements 500 (i.e. the rhomboid elements).

A power lead, for example, a coaxial cable 530 conveys the voltage waveform to the antenna. The voltage can vary from approximately 1.5V to 1000V, with a preferred range of 1.5V to 100V, and more preferred voltage of 5V since most industrial electronics are readily available at this level. On the antenna, the voltage waveform is conveyed along a conductive metallic strip with a ground plane on the other side of an insulating board. This conductive strip is commonly referred to as a stripline 505. Such striplines are known in the art and can be of various materials such as gold, silver, and other metals, but is most commonly copper. The stripline 505 conveys the voltage waveform to a power splitter, specifically, a Wilkinson power divider 512. Such dividers are known in the art and divide the power of the voltage into two equal parts. A resistor 510 is a part of the power divider to eliminate reflections of the pulse back toward the source. In turn, the pulse is conveyed along striplines 505 to a pair of additional power dividers 512 which further divides the voltage pulse, now into four voltage waveforms, each one of one quarter power of the original pulse. The four pulses are then connected to antenna elements 500. A further series of Wilkinson power dividers could further divide the pulse for more antenna elements. These arrays of antenna elements 500 combine to form the antenna. Arrays of antenna elements are known in the art; the purpose is to create a narrower beam of radiated electromagnetic energy.

The coaxial cable 530, striplines 505, and Wilkinson power dividers 512 all have the same impedance, typically 50 Ω (Ohms). The antenna elements 500 have an impedance much larger, closer to the impedance of open space, which is about 360 a To accommodate the impedance difference between the striplines from the Wilkinson power dividers and the impedance of the antenna elements, an electrical transformer 520 is installed at the connection to the antenna elements. This transformer has more windings on the antenna element side than the strip line side. This winding difference is an effective impedance converter.

The antenna elements shown in FIG. 5 are rhomboid type, which resist resonances; however, other antenna geometry can be used. The far ends of each of the rhomboid antenna elements are loaded with resistors 525 to absorb any remaining pulse energy so that the remaining energy does not reflect back toward the transformers. This is the “send” antenna; it transmits the pulse.

The “receive” antenna can be a similar separate antenna or can be the same antenna. The above discussion works in reverse; an electromagnetic pulse impinging on a receive antenna will generate voltages in the rhomboid antenna elements 500. This received energy from each of the antenna elements is combined by the power dividers 512 (which now act as power combiners). The power lead, e.g. coaxial cable 530, in this case, conveys the received voltage pulses away from the receive antenna to electronics designed to accept the pulse voltage.

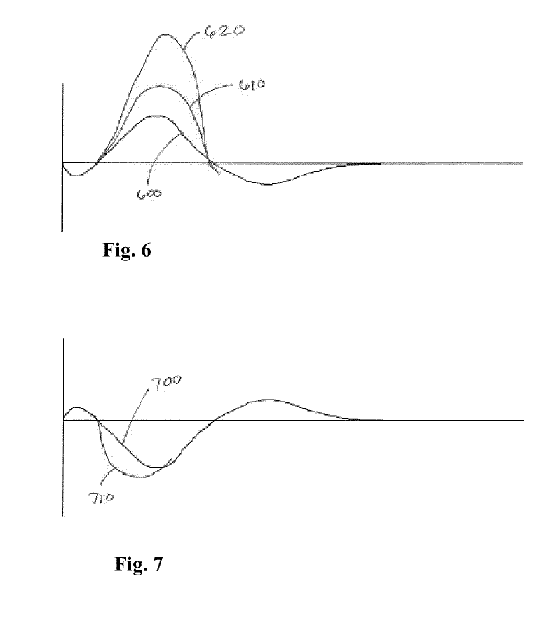

When the pulse encounters a buried object, the pulse will be reflected in all directions. A portion of the pulse will return to the antenna, which will measure a received signal. These received signals will vary based on the composition of the material or object encountered. FIG. 6 shows how various different metals might appear as return signals. Lead 600 will absorb most of the signal, reflecting only a small portion. Aluminum 610 will reflect more, while silver 620 will reflect the most. FIG. 7, like FIG. 6, shows reflected signals, but for non-metallic or dielectric materials. As one can see, the reflected signals from dielectric materials are the inverse of those from metals, as well as the inverse of the initial pulse. As with the metals, the curves of the response signals will vary by material. For example, PVC 700 will have a shallower curve than polyethylene 710.

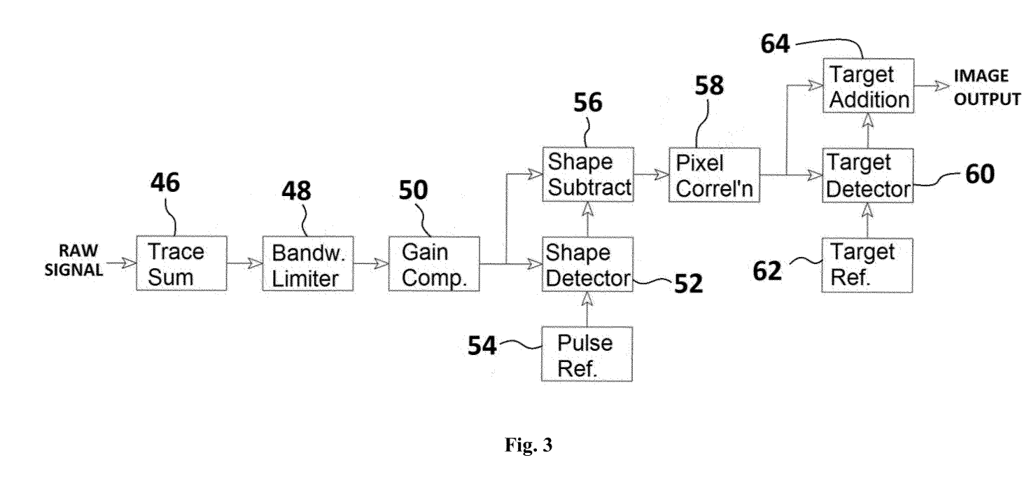

The receive antenna 22 (FIG. 2) can be of several variations, but must not significantly distort the received reflections of the initial unique, pre-programmed pulse shape and needs to have a narrow sensing beam. A narrow beam will return a more detailed image, whereas a wider beam will cover a larger area, but at the cost of lower resolution. The receive antenna 22 could be constructed the same as the transmit antenna or use the transmit antenna 20 itself. The receive amplifier 24 increases the amplitude of the receive antenna signals to be compatible with the amplitude handling ability of the analog to digital converter 26 as needed by the application. As before, this increase in amplitude can range from 1-2000 times, but is usually around 1000×. Some applications may require that the receive amplifier change its gain with time to compensate with the loss of signal strength with distance, in accordance with the inverse square law. The analog to digital converter 26 converts the received signal into a traditional binary format with a high enough speed to capture the details of the unique pulse shape. The pulse recognition unit 28 has the task of recognizing the unique, pre-programmed, specified pulse shape. (The sequence involved in pulse recognition 28 is detailed in FIG. 3, discussed below.) The reflected signals of the initial unique pulse shape will be altered, which can be predicted using Maxwell's equations. With the above triangular, asymmetrical pulse shape 420, a leading opposite polarity pulse will be added with half amplitude. After the slower decline back to zero will be an extension of opposite polarity. These two added parts to the unique, pre-programmed pulse shape 430 must be included in the recognition task. This recognition process increases the recognition of the pulses in an electrically noisy environment and with the noise created in the hardware.

In many applications it is beneficial to subtract the first trace or scan from all subsequent traces or scans to emphasize differences or movement in the target area. The first pulse trace memory means 30 records the pulse amplitudes from the first trace or scan. In those applications where it is beneficial, the pulse amplitudes of the scans after the first trace or scan are reduced by the amplitudes of the first trace or scan via subtracting means 32. To increase recognition of the unique, asymmetrical, pre-programmed pulse shape in an electrically noisy environment and the noise created in the hardware, the amplitudes along one trace are added to the prior number of traces (or N traces) via summing means 34. If appropriate, a high pass filter (not shown) can be employed for that purpose. The application dictates how many N traces can be added together without excessively slowing down the scan process. The pulse amplitudes along the traces are recorded by the trace memory 36. The individual traces are recorded in a series of memory locations according to the addresses supplied by the controller. This memory series forms the raster pattern needed to form a two-dimensional (2D) image later. For three-dimensional images (3D), the raster pattern memory is repeated in a third direction corresponding to repeated scans with movement in a third direction. These are recorded in a 2D or 3D memory 38. The image processor 40 converts the pulse amplitudes into an appropriate display format as needed by the application. The display format could be converting the amplitudes into brightness and colors. This image memory 42 records the data in the format as required for the display device 44. The Display can be a computer monitor, digital picture format, a printed image, or any other display known in the art.

An appropriate power supply is provided for all the components, although independent power supplies may be provided with the antennas. Further, the recording of the trace signals and image processing can be done via a microcontroller, microprocessor, or an appropriately programed computer. The processor receives the returned signals from the trace memory units and performs various algorithms on the data in order to derive the useful or desired information, as well as to create image data to be displayed on display device 44. Known algorithms can be used to recognize the unique pre-programmed pulse shape and changes to the pulse shape due to the target material and target shape, using polarization rotations, pulse slope changes, pulse height, and combinations of overlapping changes.

In FIG. 2 the raw signal that comes from the analog to digital converter 26 is processed to produce an image output which passes to the trace processing means identified as items 30, 32, 34 36, etc. is captured as a series of traces to be compiled, compared, etc. to produce the ultimate images.

If object recognition is to be used, the object recognition requires a normalized amplitude. The primary requirement is the decrease of amplitude with distance according to the inverse square law. This step increases the gain over the time of the trace, which is equivalent to distance. The algorithm used is the square of the time after transmission. Object recognition requires suppression of electrical noise from the environment and the hardware. To accomplish this, each trace is added to a number, N, of previous traces; N is determined as needed by the application. Thus, the raw signal from the analog to digital converter 26 is gathered with the number (N) of traces at summarizer 46 to provide a sum, which passes through a bandwidth limiter means 48 to a compensator 50, which provides a gain which compensates for the distance involved.

To reduce interference from electrical noise from the hardware and environment, the range of frequency that is detected and needed by the unique, asymmetrical, pre-programmed pulse shape is limited. This block introduces a high pass filter that attenuates frequencies below the equivalent slowest part of the unique pulse shape. Also this block introduces a low pass filter that attenuates frequencies above the equivalent fastest part of the unique pulse shape.

The shape of the unique, pre-programmed, specified pulse shape, as modified by Maxwell's equations, is translated into a series of amplitudes over time. This series is used to compare with the received signal for the purpose of recognizing the unique, pre-programmed, specified pulse shape. In an attempt to recognize the unique pulse shape, the attempt is made repeatedly along the trace versus time. The process entails accepting the amplitude averaged over the expected pulse shape and measuring the deviation at each point along the pulse shape from the corresponding point of the pre-programmed pulse shape, scaled according to the amplitude average. This process is an automatic search in the received signal for the best fit to the pre-programmed pulse shape. The result is a narrow pulse whose amplitude is the above average minus the sum of the deviations along the trace within the time range of the expected pulse shape. This replaces the unique pulse shape with a narrow pulse with amplitude proportional to the strength of the received pulse and the degree of match to the expected pre-programmed pulse shape. This facilitates creating an image of individual reflections even if they came from overlapping reflected pulses, and via the process of the present invention, provides for improved resolution and detail in the created image.

FIG. 3 shows the process for pulse recognition. This process is carried out in the pulse recognition means 28 as shown in FIG. 2. The detected pulse shape, which is done in means 52, is subtracted from the trace as if the pulse had no deviations. This is continued along the trace. The result is a string of pulses whose amplitudes represent the strength and degree of match to the pulse shape reference means 54, which is a library of possible target objects with recognition parameters, and shapes for the display. The result is a net pulse shape 56. Some applications can benefit from correlating a pixel with the surrounding pixels or with communication with repeated transmissions via means 58 to reduce noise and increase the quality of the unique, asymmetrical, pre-programmed pulse shape recognition. One version of correlation is a simple sum of the pixel with the surrounding pixels; this reduces the resolution in exchange for reduced noise. The library of references target objects or transmitted codes, the pulse shape reference 54, will have been created beforehand. It is created by directing the pulse at an object with known properties and recording the result. This can be done by burying the object in a material that has a known effect on the response signals; however, it is preferred to point the pulse at the object in an unburied state. For example, to populate the library entry for a steel pipe, a clean steel pipe would be placed in the open air on the ground, and the device aimed at the pipe and the response signal recorded and stored.

Some applications can benefit from comparing the pattern of signals in the scan with the target shape reference which is stored via means 62 of possible target objects. By measuring the degree of match of the signal pattern provided via means 60 with the expected pattern from means 62 for such an object. The result is a set of images provided via means 64 of the recognized objects, but with the amplitude representing the degree of match with the target.

The result from the target shape detector can be substituted in place of or in addition to the signals, but in a different color or as required for clarity. The reflected signals will have distortions caused by the composition of the object as well as its geometry. Multiple separate variations on the pre-programmed pulse shape can be used to determine composition of an object as well as shape of the object. Each variation can search the returning signal for the unique distortions corresponding to each variation on the pre-programmed pulse shape. All the searches for the variations can be done simultaneously. Additional colors in the resulting image can be assigned to the variations to improve clarity. Thus, the apparatus and process (or method) of the present invention can be used to detect objects, but in addition can be used to detect the characteristics of the detected object.

The apparatus or system of the present invention can be used for a broad range of applications which would involve the detection of objects that are subterranean, buried, or obscured so that the object can be detected, identified, or found, if lost. These applications may include mining, geotechnical, environmental, and safety areas. For example, applications include: detection of underground pipes and cables; detection of buried landmines and bombs;

detection of people/bodies trapped in a burning building; detection of people/bodies buried in rubble; delineation of ore bodies; detection of fault lines, and stress therein; detection of aquifers; road evaluation; and hazardous waste detection.

As used herein, “transmitted data” and “signal” are intended to be used interchangeably. Transmitted data or a signal can be used to sense objects as well as transmit a message as a method of communication. A first apparatus generates and sends a signal (transmits data) to a second apparatus, and the response back from the second apparatus is received and processed by the first apparatus, thus effecting communication. Thus, the elements or devices as described above can be employed for communication.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What I claim is:

1. An electromagnetic pulse apparatus comprising:
A. signal generating means for generating and transmitting at least one electromagnetic pulse having an asymmetrical shape;
B. return signal processing means for receiving a reflected return signal, and processing the return signal to derive useful information ; and
C. at least one antenna for sending and/or receiving signals.

2. The apparatus of claim 1 wherein the electromagnetic pulse is generated as a voltage step and is followed by a decay created by the passage of the voltage step through a capacitor or a resistor circuit.

3. The apparatus of claim 1 wherein the antenna has a rhomboid shape.

4. The apparatus of claim 1 wherein the antenna comprises an array of bowtie antenna elements.

5. The apparatus of claim 1 wherein the antenna comprises a series of bowtie antenna elements.

6. The apparatus of claim 1 further having a preprogrammed means for storing and analyzing return signals.

7. The apparatus of claim 1 further having a preprogrammed means for storing and analyzing return signals and wherein reference pulse shapes are stored therein for use in comparing and analyzing the return signals.

8. The apparatus of claim l further including means for subtracting a first return signal from a subsequent return signal to thereby detect movement.

9. An apparatus for transmitting data comprising:
A. signal generating means for generating and transmitting at least one electromagnetic pulse having an asymmetrical shape;
B. return signal processing means for receiving a return signal, and processing the return signal to derive useful information; and
C. at least one antenna for sending and/or receiving signals.

10. A method of detecting subsurface objects comprising:
A. providing a signal generating means for generating and transmitting at least one electromagnetic pulse having an asymmetrical shape;
B. providing a return signal processing means for receiving a reflected return signal, and processing the return signal to derive useful information ;
C. providing at least one antenna for sending and/or receiving signals;
D. providing a programmed means for storing and analyzing the received signals and wherein reference pulse shapes are stored therein for use in comparing and analyzing the return signals;
E. generating a signal having an asymmetrical shape;
F. receiving return signals; and
G. analyzing said return signals to thereby detect the presence of a subsurface object.
